(19) United States
(12) Patent Application Publication
(10) Pub. No.: US 2008/0119310 A1
(43) Pub. Date: May 22, 2008

(54) ROTARY TENSIONER

(76) Inventors: C. Scott Holcombe, Wilmington, NC (US); Matthew B. Neal, Wilmington, NC (US)

Correspondence Address: DANN, DORFMAN, HERRELL & SKILLMAN, 1601 MARKET STREET, SUITE 2400, PHILADELPHIA, PA, 19103-2307, US

(21) Appl. No.: 11/560,608

(22) Filed: Nov. 16, 2006

(51) Int. Cl. F16H 7/12

(52) U.S. Cl. 474/135

(57) ABSTRACT

An assembly for maintaining tension in a drive belt features a housing mounted on a base. The housing contains a biasing element that exerts torque on the housing to bias the housing. An arm is connected to the housing and rotates with the housing in response to the bias of the biasing element. A pulley is connected to the lever arm and engages a drive belt in response to the bias force of the biasing element on the lever arm. The pulley deflects the shape of the belt to provide tension in the belt. In one embodiment, the device includes one or more biasing elements that in a relaxed state have a curved configuration to correspond to the curved configuration of compartments in the housing.

### FIELD OF THE INVENTION

The present invention relates generally to tensioners, and more specifically to mechanical spring-actuated or biased tensioners for use in continuously maintaining tension in endless drive belts or chains in power transmission drive systems.

### BACKGROUND OF THE INVENTION

A variety of tensioners are known in the art for tensioning power transmission drives, such as belts. One type of tensioner uses compression springs to provide the biasing force. Although compression springs provide a low-cost option for tensioners, the use of compression springs leads to numerous problems during both manufacturing and use. For instance, the forces applied by compression springs in the known tensioners tend to create increased friction between the springs and the housing leading to premature wear on the housing and premature failure of the springs. Furthermore, special fixtures are typically required to wedge the compression springs into the tensioner housing.

### SUMMARY OF THE INVENTION

To overcome the shortcomings of the prior art tensioners, the present invention provides a tensioner that is inexpensive to produce and readily adaptable to a variety of different applications. Accordingly, the present invention provides a tensioner for tensioning a belt, comprising a housing, an arm attached to the housing and a biasing element positioned within the housing for providing a tensioning force. The housing includes a compartment for housing the biasing element and the compartment has a curved configuration. The biasing element is formed so that in a relaxed state, the biasing element has a curved configuration that follows the curved configuration of the compartment.

### DESCRIPTION OF THE DRAWINGS

The foregoing summary and the following detailed description of the preferred embodiments of the present invention will be best understood when read in conjunction with the appended drawings, in which:

FIG. 1 is a diagram of a typical application, including a belt, tensioner assembly and idler pulley.

FIG. 2a is a plan view partially broken away of the tensioner assembly shown in FIG. 1.

FIG. 2b is a plan view of the tensioner assembly shown in FIG. 2a, shown rotated 45° to a biased position.

FIG. 3 is a cross sectional view of the tensioner assembly shown in FIG. 2a taken along the line 3-3.

FIG. 4 is a plan view of a base of the tensioner assembly shown in FIG. 2a.

FIG. 5 is plan view of a biasing element of the tensioner assembly shown in FIG. 2a.

### DETAILED DESCRIPTION OF THE PREFERRED EMBODIMENTS

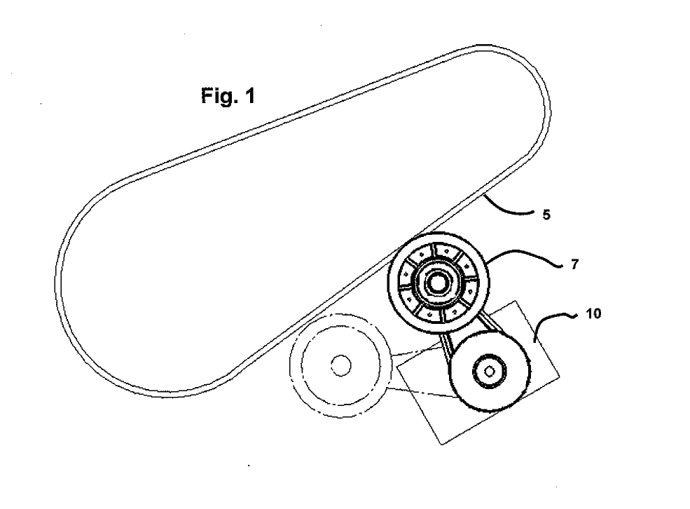

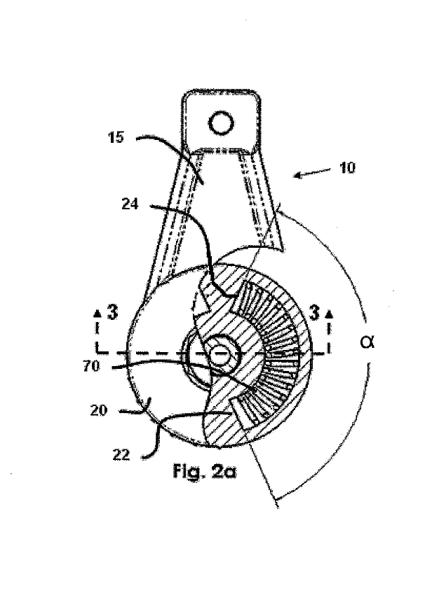

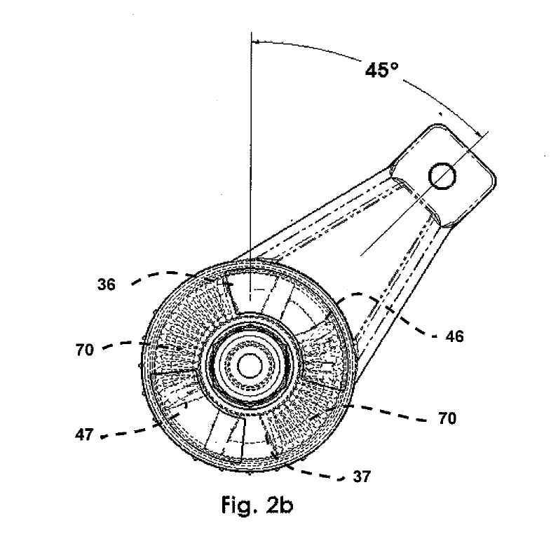

Referring now to the drawings in general, and to FIGS. 1 and 2 specifically, a tensioner apparatus is generally designated 10. The tensioner 10 biases an idler pulley 7 into engagement with a belt 5. The tensioner 10 includes an arm 15 attached to a housing 20. The arm 15 and a portion of the housing 20 pivot together relative to a base and are under bias from one or more biasing elements 70 in the housing 20. The pulley 7 is connected to the end of the arm 15 and engages the belt 5 to apply tension to the belt under the bias from the biasing element 70.

Referring now to FIGS. 2a-5 the details of the tensioner will be described in greater detail. The tensioner 10 includes a housing 20 that includes two compartments 22, 24 for housing the biasing elements 70. The housing is generally cylindrical, and is formed of a lower portion or base 30, and an upper portion or cap 40. As discussed further below, the compartments housing the biasing elements are formed such that part of each compartment is in the base and part of each compartment is in the cap. In the present embodiment, the biasing elements are springs, so the compartments will be referred to as spring compartments in the following description.

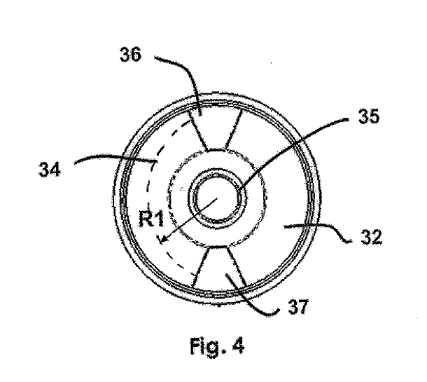

Referring to FIGS. 2a and 4, the details of the base 30 will be described in greater detail. The base is generally cylindrical, having a central bore 35, through which a fastener extends to attached the tensioner to a machine element, as described further below. The base 30 also includes a pair of grooves 32, 34 that form the lower part of spring compartments 22, 24. Walls 36, 37 are formed between the grooves to separate the grooves from one another. The walls 36, 37 operate as end walls that the springs 70 bear against during use of the tensioner.

The grooves 32, 34 are formed in a curved shape. In the present instance, the grooves follow an arc-shaped curve. For instance, groove 32 has a centerline along the center of the groove. The centerline generally follows an arc having a radius R₁. The groove extends along an arc that preferably is greater than 45° and less than 180° in length. Further, in the present embodiment, the second groove 34 is substantially a mirror of the first groove 32. Additionally, in the present instance, the bottom surface of grooves 32, 34 are rounded to correspond to the curvature of the convolutions of the springs 70.

The cap 40 overlies the base 30 to enclose the springs 70 within the device. Additionally, an elongated arm 15 is attached to the cap. The arm 15 is configured to be connected with a machine element. For instance, in the present instance, the arm 15 includes a mounting hole positioned remote from the cap 40 that can be used to attach a pulley to the arm so that the tensioner can be used to tension a belt. In the present instance, the arm is integrally formed with the cap so that the arm and cap are a single piece. However, it may be desirable to form the arm and the cap separately so that the arm can be removably attached to the cap if desired.

The cap includes a central opening for receiving the hub 50 and a generally cylindrically-shaped body that is configured substantially similarly to the base 30. In the present instance, the body of the cap comprises two grooves 42, 44 that are formed to be substantial mirrors of the grooves 32, 34 in the base. In this way, when the cap 40 is placed over the base 30, the upper grooves 42, 44 overlie the lower grooves 32, 34 to form the spring compartments 22, 24. Since the grooves 32, 34, 42, 44 are curved with rounded bottoms, the spring compartments are shaped like a segment of a torus. Although the spring compartments can be shaped in various configurations, the spring compartments are shaped to correlate to the configuration of the springs to minimize the wear between the springs and the spring compartments during use. More specifically, the spring compartments are in the shape of less than a 180° segment of a torus. Further, the spring compartments are in the shape of at least a 45° segment of a torus and in the present instance the spring compartments are in the shape a segment of a torus that extends through an angle identified in FIG. 2a as α, which is at least 90°.

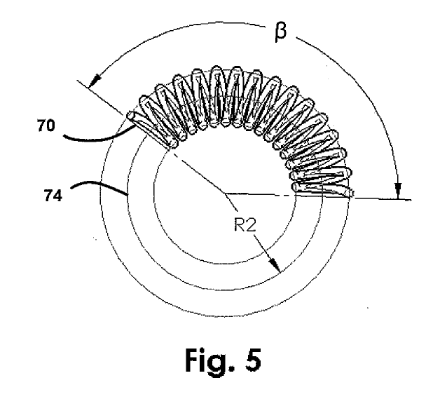

The tensioner includes at least one biasing element 70. Although the bias may be provided by a number of different types of elements, in the present instance the biasing element or elements are configured so that in an unbiased state the biasing element can be inserted into the spring compartments without significantly tensioning or compressing the spring. In the present instance, the biasing element is configured in the shape of a partial torus, similar to the shape of the spring compartments. The biasing element may be in the shape of at least a 45° segment of a torus, and in the present instance is in the shape of a torus segment that extends through an angle identified as β in FIG. 5, which is at least 90°.

Although the number of biasing elements can vary, in the present instance the tensioner 10 includes two biasing elements 70 that are disposed symmetrically within the housing to balance the biasing forces when the device is rotated. Specifically, as shown in FIG. 4, the grooves that form the spring compartments are symmetric about a centerline through the housing. Accordingly, the tensioner includes two similarly configured biasing elements, one in each of the spring compartments.

Although the type of biasing element may vary, in the embodiment illustrated in FIG. 2a each biasing element 70 is a coiled compression spring. The spring is formed of a plurality of overlapping convolutions. Each convolution has substantially the same diameter along the majority of the length of the spring. However, the diameter of the last few convolutions at each end of the spring may be smaller than the diameter of the convolutions in the rest of the spring.

As noted above, in its relaxed state, the spring is in the form of a segment of a torus, and further, the segment is greater than 45° and less than 180°. As shown in FIG. 5, the spring 70 has a centerline 74 that passes through the center of the convolutions. The center line follows an arc having a radius that is identified as R₂ in FIG. 5.

In its relaxed state, the spring 70 is formed to correspond to the shape of the spring compartment 22 or 24. More specifically, the curvature of the spring corresponds to the curvatures of the spring compartment so that the spring 70 can be inserted into the spring compartment without significantly bending or compressing the spring. In other words, the spring is configured to mate with the spring compartment so that the spring is essentially in a relaxed state in the spring compartment or is under minimal compression.

One measure of the similarity between the relaxed state configuration of the spring and the configuration of the spring compartment relates to the radii of curvature of the two. As shown in FIG. 4, the radius of curvature of the centerline of the groove forming part of one of the spring compartments is designated R₁, and the radius of curvature of the centerline of the spring in a relaxed state is designated R₂. To provide similarity between the spring and the spring compartment, the ratio of R₁ to R₂ is less than 2.0, and more desirably is less than 1.5. Additionally, the ratio of R₁ to R₂ is preferably greater than 0.5, and more desirably is greater than 0.67. In the present instance, the ratio of R₁ to R₂ is between 0.8 and 1.2 and preferably is between 0.9 and 1.1.

The cap 40 and the attached arm 15 pivot about a hub 50, which is connected to the base 30. The hub is generally cylindrical, having a first end that forms an enlarged diameter head 52 and a second end 54 that forms a smaller diameter, which includes a threaded portion 54. As discussed below, the threaded portion engages the base 30 to connect the hub to the base in a manner that impedes rotation of the hub relative to the base.

The hub 50 is hollow, having a central bore, and the length of the hub between the head 52 and the threaded portion 54 is generally cylindrical. A shoulder 56 is formed in the hub adjacent the threaded end 54. The shoulder 56 confronts, but does not necessarily abut the base 20 when the threaded end 54 is threaded into the base 30. The cooperation of the threaded end with the base operates as a stop limiting the distance that the hub is inserted into the housing. However, as discussed below, in the present instance, the shoulder of the hub contacts the base, acting as a stop to maintain the proper spacing between the base and the cap.

The bore of the hub 50 is configured to receive a fastener that is operable to attach the tensioner 10 to a machine element. The fastener may be any of a variety of common fastening elements, such as a bolt with a flat head. The bore of the hub is larger than the bolt and the length of the bolt extends through the hub without interfering with the bore of the hub.

In the foregoing description, the hub is described as having a hollow bore. However, it may be desirable to use a hub 50 having a threaded bore so that the fastener can thread into the hub, such as through the base 30 and into the shaft, in order to attach the tensioner to a machine element. Further, the fastener can be any of a variety of types of fasteners.

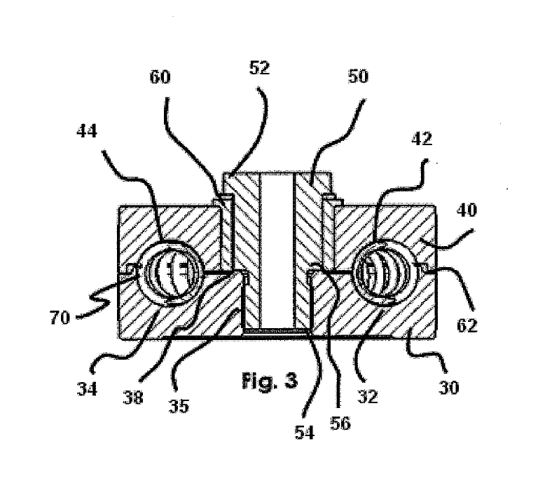

The tensioner 10 operates such that the spring 70 is disposed between the cap 40 and the base 30, and the base is maintained stationary while the cap 40 pivots about the hub 50 in response to the load on the item being tensioned. To improve the pivoting motion of the tensioner, it may be desirable to include one or more bearing elements between the various elements. For instance, as illustrated in FIG. 3, the present embodiment includes a bushing 60 disposed between the hub 50 and the cap 40. The bushing 60 is positioned within the cap so that the hub 50 bears against the interior of the bushing. The bushing 60 is configured to be press fit into the bore though the cap 40 to form a bearing surface between the cap and the hub. In this way, the shaft bushing provides a smooth wear surface with a relatively low coefficient of friction so that the cap can pivot smoothly relative to the hub.

The bushing 60 may be a simple cylindrical liner. However, it may be desirable to utilize a bushing having a flared head, as shown in FIG. 3. Specifically, the bushing 60 may include a head that flares outwardly so that the head of the bushing is disposed between the top surface of the housing and the bottom surface of the flared head 52 of the hub 50. Configured in this way, the shaft bushing also provides a smooth wear surface with a relatively low coefficient of friction between the head of the hub and the top surface of the cap 40.

In addition to the bushing 60, it may be desirable to include an element that provides a gap between the cap 40 and the base 20. In the present instance, referring to FIG. 3, the base 30 includes a boss 38 that forms an annular ridge protruding from the top surface of the base around the central bore 35. The shoulder 56 of the hub 50 rests on the boss 38 to maintain a gap 62 between the cap and the base 30 to allow the cap to rotate relative to the base. To reduce wear between the base 30, cap 40 and springs 70, preferably the springs are coated with grease in the spring compartments 22, 24. Additionally, to impede the migration of contaminants into the spring compartments, a sealing element may be provided between the head of the bushing 60 and the head of the hub 50. For instance, a compressible washer, such as a felt washer may be disposed between the head of the hub 50 and the head of the bushing 60.

The bushing 60 is formed from a material that is softer and/or smoother than the material from which the base, cap and hub are formed. In this way, the base, hub and cap can be formed from materials with less regard to wear durability. For instance, the base and cap may be formed of aluminum, the hub may be formed of steel, and the bushing 60 may be formed of bronze.

Configured as described above, the tensioner 10 is assembled as follows. The base bushing 60 is press fit into the central hub 40 of the cap. The springs 70 are inserted into the spring compartments, preferably without significantly deforming the springs. Grease is applied to the springs and the cap is placed over the base so that the grooves in the cap 42, 44 overlie the grooves in the base 32, 34. The hub is then inserted through the bore of the cap so that the threaded end 54 threadedly engages the threaded bore 35 in the base. In the present instance, a bonding element, such as LOCTITE is applied to the threads to bond the threaded portions together to substantially permanently fix the hub relative to the base. A machine element, such as a pulley is then attached to the end of the arm 15.

A fastener is inserted through the hub 50 and threaded into the machine element to attach the tensioner to the machine element. The fastener tightens down against the hub 50 to tighten the base against the machine element. However, the hub is fixed relative to the base, so that tightening down against the hub does not significantly tighten the cap against the base. In this way, the cap 40 is free to rotate relative to the base after the device is mounted onto the machine element.

The tension provided by the tensioner 10 can be easily set as desired for the particular application. For instance, in the embodiment illustrated in FIG. 1, to set the tension, the unit is fixed at a predetermined position by tightening the fastener. The tensioner arm 15 is then rotated clockwise, past the point of engagement with the element being tensioned, which in the present instance is a belt (the belt will need to be displaced to allow the pulley to be displaced past the belt). The arm is then released so that the springs displace the arm counter-clockwise until the pulley engages the belt. The tensioning force may be increased after the pulley is already in engagement with the item being tensioned, which is described as follows. The fastener attaching the device to the machine is loosened, and the tension is increased by rotating the base. This can be done using a wrench to engage the flats on the head 52 of the hub 50. Since the hub is connected to the base, rotating the hub rotates the base, and since the arm is held back by the pulley engaging the belt, rotating the hub rotates the base relative to the cap, thereby increasing the compression of the springs 70.

The tensioner assembly 10 may be attached to the frame of a device or onto a mounting assembly attached to a device. Referring to FIG. 1, the tensioner assembly 10 is assembled so as to engage the belt in the position shown (“engaging position”). Before the belt 5 is assembled, the tensioner assembly 10 would typically be assembled with the arm 15 pivoted into a position rotated approximately 90 degrees from the engaging position (such as that shown in phantom lines). This position (“relaxed position”) would not have any significant biasing load generated by the spring 70 because there would be no significant deflection in the springs.

When the belt is assembled, the tensioner arm 15 is rotated to the engaging position. During rotation of the arm 15, the cap 40 rotates in a radial direction around the pivot axis. By rotating the cap 40, the end walls 46, 47 of the grooves 42, 44 in the cap rotate clockwise relative to end walls 36, 37 in the grooves 32, 34 in the base 30 (as shown in FIG. 2b). The movement of the end walls 46, 47 in the cap relative to the end walls in the base compresses the springs 70 within the spring compartments 22, 24 to provide a bias in the tensioner. In general, the bias force in the spring is proportional to the amount of deflection caused by rotation. The bias force is transferred through the lever arm 15 to the idler pulley 7 at the end of the arm. The idler pulley 7, in turn, pushes on the belt 5 and deflects the shape of the belt. The deflection of the belt removes the slack in the belt.

The terms and expressions which have been employed are used as terms of description and not of limitation. There is no intention in the use of such terms and expressions of excluding any equivalents of the features shown and described or portions thereof. It is recognized, therefore, that various modifications are possible within the scope and spirit of the invention. For instance, in the foregoing description, the tensioner includes a bushing to improve the interface between the shaft, base and housing. In certain applications it may desirable to utilize bearing elements that incorporate ball bearings. Similarly, rather than using a separate bushing, the elements could be plated or coated with a material that provides the desired wear surface. Accordingly, the term bearing element for the shaft, base or housing is meant to include any type of liner, bushing, ball bearing, plating or coating, which provides a property or characteristic separate from the material from which the corresponding element (i.e. the hub, base or housing) is formed. Accordingly, the invention incorporates variations that fall within the scope of the following claims.

1. A tensioner for tensioning a belt, comprising:
a housing, comprising:
a lower portion;
an upper portion pivotable relative to the lower portion;
a biasing element chamber having a curved configuration generally following an arc of greater than 45 degrees and less than 180 degrees, and having a first radius passing through the center of the biasing chamber, wherein the biasing element chamber comprises:
a bottom portion formed in the lower portion of the housing; and
a top portion overlying the bottom portion, formed in the upper portion of the housing;
an arm attached to the housing, extending outwardly from the housing wherein the end of the arm remote from the housing is adapted to connect with an engagement element for tensioning the belt; and
a biasing element positioned within the biasing element chamber, wherein when the biasing element is in a relaxed state the biasing element has a central axis of curvature following a second radius, wherein the ratio of the first radius to the second radius is less than 1.5, and wherein when the spring is in a relaxed state the curvature of the biasing elements generally extends through an arc of greater than 45 degrees and less than 180 degrees;
wherein rotating the lower portion of the housing relative to the upper portion of the housing compresses the biasing element to produce a biasing force.

2. The tensioner of claim 1 wherein the biasing element chamber has a length and the biasing element has a length that is substantially similar to the length of the biasing element chamber.

3. The tensioner of claim 1 wherein the biasing element is a compression spring.

4. The tensioner of claim 3 wherein the biasing element is formed of a plurality of overlapping convolutions, wherein the central axis passes through each convolution and when the spring is in a relaxed state the central axis is curved, generally following an arc that is substantially similar to the arc followed by the configuration of the biasing element chamber.

5. The tensioner of claim 4 wherein the central axis follows an arc having a radius of at least ½ inch.

6. The tensioner of claim 5 wherein the central axis follows an arc having a radius of less than 5 inches.

7. (canceled)

8. The tensioner of claim 1 wherein the ratio of the first radius to the second radius is less than 1.5.

9. The tensioner of claim 1 wherein the ratio of the first radius to the second radius is less than 1.1.

10. The tensioner of claim 1 wherein the curvature of the biasing element generally follows a curve of greater than 90 degrees.

11. The tensioner of claim 1 comprising a second biasing element chamber having a curved configuration generally following an arc of greater than 45 degrees and less than 180 degrees, and a second biasing element positioned within the second biasing element chamber, wherein the second biasing element has a curved configuration when the biasing element is in a relaxed state, wherein when the spring is in a relaxed state the curvature of the biasing elements generally follows an arc of greater than 45 degrees and less than 180 degrees.

12. A tensioner for tensioning a belt, comprising:
a housing, comprising:
a base;
a cover; and
a spring compartment for housing at least a portion of the spring, wherein the spring compartment is formed in the base or the cover and the compartment has an arcuate configuration having first and second end walls, and a central axis having an arc following a first radius;
an arm attached to the housing, extending outwardly from the housing;
a compression spring positioned within the housing, operable to provide a biasing force when the base is rotated relative to the cover, wherein the compression spring has an arcuate configuration having a central axis following a second radius when the spring is in a relaxed state wherein the ratio of the first radius to the second radius is less than 2.

13. The tensioner of claim 12 wherein the first and second end walls of the spring compartment form stops limiting the movement of the compression spring during use.

14. The tensioner of claim 12 wherein the curved compartment comprises an upper portion formed in the cover and a lower portion formed in the base.

15. The tensioner of claim 14 wherein the upper portion overlies that spring and the lower portion to enclose the spring within the compartment.

16. The tensioner of claim 12 wherein the curved compartment is configured so that the compartment generally curves along an arc of at least approximately 45 degrees.

17. The tensioner of claim 12 wherein the compartment generally curves along an arc of at least approximately 90 degrees, but less than approximately 180 degrees.

18. The tensioner of claim 12 wherein the spring comprises a plurality of overlapping convolutions, and a majority of the convolutions have approximately the same diameter.

19. The tensioner of claim 12 wherein:
the ratio of the first radius to the second radius is between approximately 0.67 and 1.5.

20. The tensioner of claim 19 wherein the ratio is between approximately 0.8 and 1.2.

21. A tensioner for tensioning a belt, comprising: a housing, comprising a curved spring chamber following a segment of less than 180 degrees and having a central axis following a first radius;
an arm attached to the housing, extending outwardly from the housing wherein the end of the arm remote from the housing is adapted to connect with an engagement element for tensioning the belt; and
a spring having a partial toroidal-shape having a certal axis following a second radius when the spring is in a relaxed state, wherein the spring is disposed in the spring chamber and is operable to provide a biasing force, and wherein the ratio of the first radius to the second radius is less than 2.0;
wherein rotating a portion of the housing compresses the spring to produce the biasing force.

22. The tensioner of claim 21 wherein the partial toroidal-shape of the spring corresponds to the configuration of the spring chamber.

23. The tensioner of claim 21 wherein the spring has the shape of at least a 45° segment of a torus.

24. The tensioner of claim 21 wherein the ratio of the first radius to the second radius is between 0.67 and 1.5.
